(19) United States
(12) Patent Application Publication
(10) Pub. No.: US 2025/0248373 A1
(43) Pub. Date: Aug. 7, 2025

(54) SELF-CLEANING AQUARIUM SYSTEM WITH HYDROSTATIC EQUILIBRIUM FLUSH MECHANISM USING A DOUBLE WALL SYSTEM TO REMOVE DEBRIS

(71) Applicant: Crave Products, Inc., Palatine, IL (US)

(72) Inventor: David Turover, Northbrook, IL (US)

(21) Appl. No.: 19/044,023

(22) Filed: Feb. 3, 2025

Related U.S. Application Data
(60) Provisional application No. 63/549,252, filed on Feb. 2, 2024.

(51) Int. Cl. A01K 63/04

(52) U.S. Cl. CPC A01K 63/045

(57) ABSTRACT

A self-cleaning aquarium system employs a low-tech, efficient design harnessing natural laws of physics and gravity for rapid debris removal. The aquarium tank features a concealed, hollow chamber positioned on a floor of an aquarium tank supporting a suspended mesh, net, or grill that acts as an under-gravel filter for the substrate. The hollow chamber is continuous and extends to the rear of the tank, integrating a gravel wall for holding gravel in place within the aquarium tank and a preferably sliding, removable wall forming a vertical chamber at the rear of the aquarium tank between the sliding, removable wall and a rear wall of the aquarium tank.

### CROSS-REFERENCE TO RELATED APPLICATIONS

The present invention claims priority to U.S. Prov. Pat. App. No. 63/549,252, titled “Self-Cleaning Aquarium System,” filed Feb. 2, 2024, which is incorporated herein by reference in its entirety.

### TECHNICAL FIELD

The present invention provides a self-cleaning aquarium system, which employs a low-tech, efficient design harnessing natural laws of physics and gravity for rapid debris removal. The aquarium tank features a concealed, hollow chamber positioned on a floor of an aquarium tank supporting a suspended mesh, net, or grill that acts as an under-gravel filter for the substrate. The hollow chamber is continuous and extends to the rear of the tank, integrating a gravel wall for holding gravel in place within the aquarium tank and a preferably sliding, removable wall forming a vertical chamber at the rear of the aquarium tank between the sliding, removable wall and a rear wall of the aquarium tank.

### BACKGROUND

Aquariums are becoming increasingly popular for home and office use. An aquarium tank must be cleaned every few days to maintain an optimal water quality for the aquatic life. Water quality is affected by a number of items, such as debris from fish waste, uneaten food, dust, leftover food, all of which contribute to impurities in the aquarium water. This accumulation of debris not only makes an unsightly and undesirable appearance of the aquarium but also endangers the aquatic animals residing in the aquarium.

A typical aquarium requires a person to manually remove water and, if present, may remove aquatic creatures that require the water for survival, and vacuum a substrate, the substrate being typically comprised of gravel or rocks. The water, as noted above, contains significant impurities and debris that must be removed from the aquarium. For smaller desktop aquariums, a person may use a turkey baster to remove the debris. A user typically manually refills the aquarium tank with clean water, an amount equal to the amount of water which was removed. Cleaning an aquarium is not typically desirable because it is labor intensive and time consuming. As noted, the aquarium must be cleaned, otherwise, a dangerous situation results for the aquatic animals residing in the aquarium.

The conventional cleaning methods are not highly effective in cleaning the aquarium to an acceptable or safe level. Thus, a need exists for more efficient apparatus, systems and methods for cleaning an aquarium tank.

In addition, a need exists for aquarium tank cleaning apparatus, systems and methods that maintain and restore optimum water quality in the aquarium tank. Further, a need exists for aquarium tank cleaning apparatus, systems and methods that are easy to operate, such that a user thereof may implement the same using a one-handed operation, for example.

Moreover, a need exists for aquarium tank cleaning apparatus, systems and methods that provide for cleaning of the aquarium tank without removal of aquatic animals, rocks, plants, decorations or other like material within the aquarium tank.

Still further, a need exists for aquarium tank apparatus, systems and methods that provide for cleaning of the aquarium tank without requiring electricity or mechanical filtration. In addition, a need exists for aquarium tank apparatus, systems and methods that provide a self-contained cleaning device that is environmentally friendly and does not require the use of sophisticated and complicated technology.

### SUMMARY OF THE INVENTION

The present invention provides a self-cleaning aquarium system, which employs a low-tech, efficient design harnessing natural laws of physics and gravity for rapid debris removal.

To this end, in an embodiment of the present invention, an aquarium tank is provided. The aquarium tank comprises: a space defined by at least a front wall, first and second side walls, and a bottom wall; a debris collecting chamber on the bottom wall within the space; a filtering medium at a top of the debris collecting chamber configured to collect debris therein; a first back wall near a rear of the of the aquarium tank; a second back wall behind the first back wall forming a vertical chamber between the first back wall and the second back wall, wherein the vertical chamber is open to the debris collecting chamber; and an outlet at or near the top of the second back wall, configured to allow water and debris to flow therethrough from the debris collecting chamber and through the vertical chamber.

It is, therefore, an advantage and objective of the present invention to provide more efficient apparatus, systems and methods for cleaning an aquarium tank.

In addition, it is an advantage and objective of the present invention to provide aquarium tank cleaning apparatus, systems and methods that maintain and restore optimum water quality in the aquarium tank.

Further, it is an advantage and objective of the present invention to provide aquarium tank cleaning apparatus, systems and methods that are easy to operate, such that a user thereof may implement the same using a one-handed operation, for example.

Moreover, it is an advantage and objective of the present invention to provide aquarium tank cleaning apparatus, systems and methods that provide for cleaning of the aquarium tank without removal of aquatic animals, rocks, plants, decorations or other like material within the aquarium tank.

Still further, it is an advantage and objective of the present invention to provide aquarium tank apparatus, systems and methods that provide for cleaning of the aquarium tank without requiring electricity or mechanical filtration.

In addition, it is an advantage and objective of the present invention to provide aquarium tank apparatus, systems and methods that provide a self-contained cleaning device that is environmentally friendly and does not require the use of sophisticated and complicated technology.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations.

FIG. 1 illustrates a side view of an aquarium tank with a double wall cleaning system in an embodiment of the present invention.

FIG. 2 illustrates a perspective view of an aquarium tank with a double wall cleaning system in an embodiment of the present invention.

FIG. 3 illustrates a perspective view of an aquarium tank with a double wall cleaning system with a catch basement at a rear thereof in an embodiment of the present invention.

FIG. 4 illustrates a water passage apparatus for fitting under an aquarium tank to route water therethrough in an embodiment of the present invention.

FIG. 5 illustrates a side view of an aquarium tank having a double wall cleaning system with a water passage apparatus fitted thereunder for routing water therethrough in an embodiment of the present invention.

FIG. 6 illustrates a perspective view of an aquarium tank with a double wall cleaning system with a gutter for moving water to a side of the aquarium tank for catching the water in a catchment basis at the side of the aquarium tank.

FIG. 7 illustrates a side view of an aquarium tank with a double wall cleaning system with a gutter for moving water to a side of the aquarium tank in an embodiment of the present invention.

### DETAILED DESCRIPTION OF THE PRESENTLY PREFERRED EMBODIMENTS

The present invention provides a self-cleaning aquarium system, which employs a low-tech, efficient design harnessing natural laws of physics and gravity for rapid debris removal.

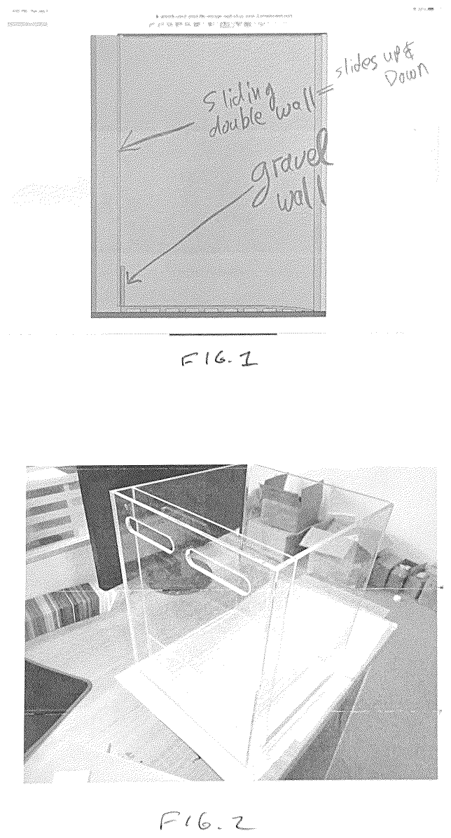

As illustrated in FIGS. 1-7 and Appendix A to the Specification, various embodiments show an aquarium tank featuring a concealed, hollow chamber positioned on a floor of an aquarium tank supporting a suspended mesh, net, or grill that acts as an under-gravel filter for the substrate. The hollow chamber may be continuous and may extend to the rear of the tank, integrating a gravel wall for holding gravel in place within the aquarium tank and a preferably sliding, removable wall forming a vertical chamber at the rear of the aquarium tank between the sliding, removable wall and a rear wall of the aquarium tank. The slidable, removable wall may be removed and replaced, such as for repair or to change the look of the wall. For example, the removable wall may be a first color, and it may be desired to have the wall of a different color therein. Likewise, the removable wall may have an image on it, and may be swapped with a wall having an alternate image thereon.

Water entering the aquarium tank, such as through the top of the aquarium tank moves water downward through the tank, through the concealed, hollow chamber, thereby flushing debris from the concealed, hollow chamber, then up through the vertical chamber, and out through one or more openings.

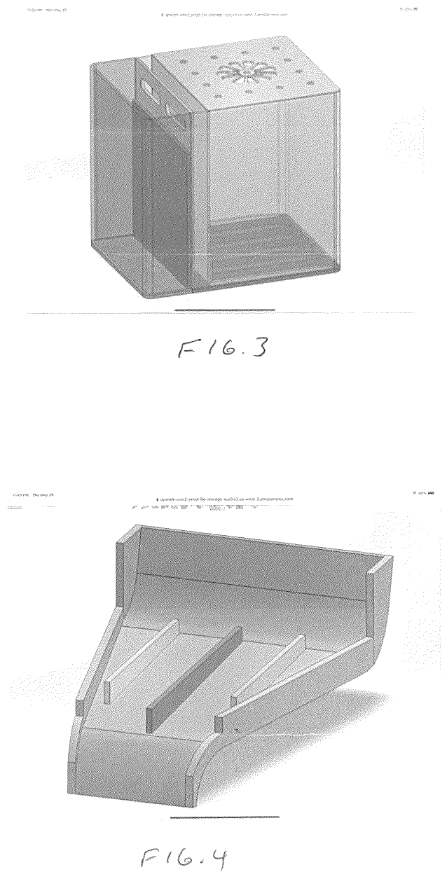

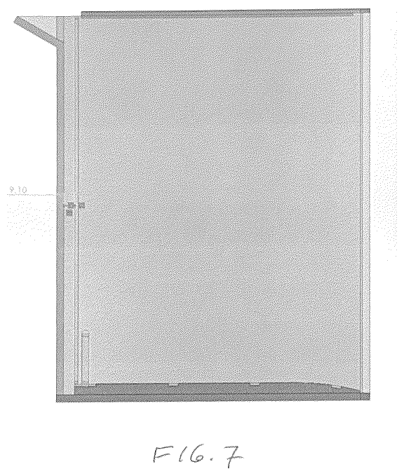

The rear wall of the aquarium may have various ways of moving water from the vertical chamber, such as via apertures or slits, as illustrated in FIGS. 2 and 3, via one or more spouts, as illustrated in FIG. 5, and/or via an angled gutter that may move water and debris to the side of the aquarium tank for catchment thereof, as illustrated in FIGS. 6 and 7. During cleaning, introducing clean water into the main body initiates a sequence: the horizontal chamber directs debris and excess water to the vertical chamber, ultimately expelling waste through the apertures, slits, spouts, or gutter. The debris may be efficiently collected in a separate tank or directed to a stand beneath the aquarium, guiding dirty water into a catchment basin or bucket.

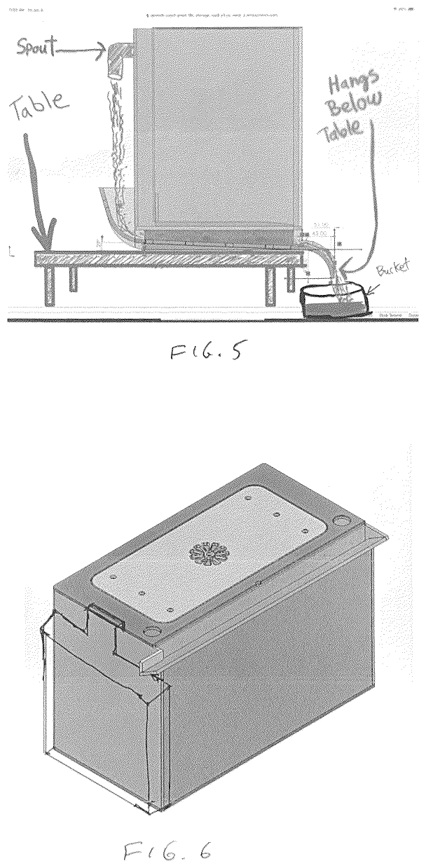

FIG. 3 illustrates a catchment basin disposed on a rear of the aquarium, such that water and debris may flow up through the vertical chamber, through the slits, and into the rear catchment basin, which may preferably be removable for dumping the same. FIGS. 4 and 5 illustrate a water passage apparatus disposed beneath the aquarium tank for catching water and debris that may flow from spouts from the rear of the vertical chamber, and direct the water and debris under the aquarium tank to a bucket or catchment basis disposed beneath and in front of the aquarium tank, thereby utilizing gravity to direct the water. FIG. 6 illustrates a catchment basin that may be positioned on a side of the aquarium tank for catching the water and debris that may flow from the vertical chamber through a gutter at or near a top of the vertical chamber and running the width of the vertical chamber.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. An aquarium tank comprising:
a space defined by at least a front wall, first and second side walls, and a bottom wall;
a debris collecting chamber on the bottom wall within the space;
a filtering medium at a top of the debris collecting chamber configured to collect debris therein;
a first back wall near a rear of the of the aquarium tank;
a second back wall behind the first back wall forming a vertical chamber between the first back wall and the second back wall, wherein the vertical chamber is open to the debris collecting chamber; and
an outlet at or near the top of the second back wall, configured to allow water and debris to flow therethrough from the debris collecting chamber and through the vertical chamber.
